(19) United States
(12) Patent Application Publication
(10) Pub. No.: US 2025/0316721 A1
(43) Pub. Date: Oct. 9, 2025

(54) FABRICATION OF INTEGRATED METAL SUPPORT FOR HIGH POWER DENSITY SOLID OXIDE FUEL CELL

(71) Applicant: Hamilton Sundstrand Space Systems International, Inc, Windsor Locks, CT (US)

(72) Inventors: Tianli Zhu, Glastonbury, CT (US); John A. Sharon, West Hartford, CT (US); Anthony Patrick Ventura, Glastonbury, CT (US); Sean C. Emerson, Broad Brook, CT (US); Zissis A. Dardas, Worcester, MA (US); Weilong Zhang, Glastonbury, CT (US)

(21) Appl. No.: 18/342,028

(22) Filed: Jun. 27, 2023

(51) Int. Cl. H01M 8/0254; H01M 8/12; H01M 8/1246

(52) U.S. Cl. CPC H01M 8/0254; H01M 8/1246; H01M 2008/1293

(57) ABSTRACT

A method of forming a fuel cell layer includes forming a separator plate including a plurality of corrugations defining a plurality of anode flow channels at a first side of the separator plate and a plurality of cathode flow channels at a second side of the separator plate opposite the first side. A support layer is formed, including a porous portion and a solid portion at least partially surrounding the porous portion. The support layer and the separator plate are stacked, and the support layer is secured to the separator plate via a field-assisted sintering or spark plasma sintering (FAST) process.

### STATEMENT OF FEDERAL SUPPORT

This invention was made with government support under Government Contract No. DE-EE0008080 awarded by the Department of Energy. The Government has certain rights in the invention.

### BACKGROUND

Exemplary embodiments pertain to the art of fuel cells, and in particular to fuel cell configurations having high power density for use in, for example, aircraft applications.

The increased use of electrical power in aircraft systems and propulsion requires advanced electrical storage systems and/or a chemical to electrical power conversion system to generate adequate amounts of electrical power. Both high system efficiency and high power density of the conversion system are required.

Fuel cell-based power systems, such as solid oxide fuel cell (SOFC)-based power systems, are able to achieve electrical efficiencies of 60% or greater. Further, SOFC power systems can operate with a variety of fuels and are scalable to achieve different power levels. Current, state of the art SOFC systems, however, have relatively low power densities of below 500 watts per kilogram, and relatively slow startup times typically exceeding 30 minutes. For aircraft and aerospace applications, increased power densities and reduced startup times are required.

### BRIEF DESCRIPTION

In one exemplary embodiment, a method of forming a fuel cell layer includes forming a separator plate including a plurality of corrugations defining a plurality of anode flow channels at a first side of the separator plate and a plurality of cathode flow channels at a second side of the separator plate opposite the first side. A support layer is formed, including a porous portion and a solid portion at least partially surrounding the porous portion. The support layer and the separator plate are stacked, and the support layer is secured to the separator plate via a field-assisted sintering or spark plasma sintering (FAST) process.

Additionally or alternatively, in this or other embodiments a catalyst layer is interposed between the support layer and the separator plate.

Additionally or alternatively, in this or other embodiments the securing is performed at a temperature in the range of less than or equal to 1000 degrees Celsius.

Additionally or alternatively, in this or other embodiments the securing is performed at a pressure in the range of 5 to 100 Megapascals.

Additionally or alternatively, in this or other embodiments the porous portion of the support layer is formed by laser drilling.

Additionally or alternatively, in this or other embodiments anode, electrolyte and cathode layers are applied to the support layer.

Additionally or alternatively, in this or other embodiments at least one of the anode, electrolyte and cathode are formed as tape casted ceramic layers.

Additionally or alternatively, in this or other embodiments one or more of the anode, electrolyte and cathode are secured via one of a FAST or spark plasma sintering process.

Additionally or alternatively, in this or other embodiments a thin conductive layer having a thickness in the range of 5 micrometers to 1 millimeter is applied to the support layer. The thin conductive layer is formed primarily of elements from groups 7-12 of the periodic table.

Additionally or alternatively, in this or other embodiments the thin conductive layer is one of a nickel or nickel alloy.

Additionally or alternatively, in this or other embodiments the thin conductive layer is applied via one of electroplating, atomic layer deposition, sputtering, or physical vapor deposition.

Additionally or alternatively, in this or other embodiments the thin conductive layer is applied prior to securing the support layer to the separator plate.

Additionally or alternatively, in this or other embodiments at least one of the separator plate or the support layer are formed from a stainless steel material.

In another embodiment, a method of forming a stacked solid oxide fuel cell includes forming a plurality of fuel cell layers. Each fuel cell layer is formed by forming a separator plate including a plurality of corrugations defining a plurality of anode flow channels at a first side of the separator plate and a plurality of cathode flow channels at a second side of the separator plate opposite the first side, and forming a support layer. The support layer includes a porous portion and a solid portion at least partially surrounding the porous portion. The support layer and the separator plate are stacked, and the support layer is secured to the separator plate via a field-assisted sintering or spark plasma sintering (FAST) process to define the fuel cell layer. The plurality of fuel cell layers are stacked along a stacking axis.

Additionally or alternatively, in this or other embodiments the securing is performed at a temperature less than or equal to 1000 degrees Celsius.

Additionally or alternatively, in this or other embodiments the securing is performed at a pressure in the range of 5 to 100 Megapascals.

Additionally or alternatively, in this or other embodiments anode, electrolyte and cathode layers are applied to the support layer.

Additionally or alternatively, in this or other embodiments a thin conductive layer having a thickness in the range of 5 micrometers to 1 millimeter is applied to the support layer. The thin conductive layer is formed primarily of elements from groups 7-12 of the periodic table. The thin conductive layer is applied via one of electroplating, atomic layer deposition, sputtering, or physical vapor deposition.

In yet another embodiment, a fuel cell layer of a multi-layer fuel cell, includes a cathode, an anode, and an electrolyte positioned between the anode and the cathode. A support layer is located at the anode opposite the electrolyte, and a separator plate is located at the support layer opposite the anode. The support layer is configured to contact the cathode of an adjacent fuel cell layer. The separator plate defines a plurality of anode flow channels configured to deliver a fuel therethrough and a plurality of cathode flow channels configured to deliver an air flow therethrough. The support layer is secured to the separator plate via a field-assisted sintering or spark plasma sintering (FAST) process.

Additionally or alternatively, in this or other embodiments a thin conductive layer is applied to the support layer having a thickness in the range of 5 micrometers to 1 millimeter. The thin conductive layer formed primarily of elements from groups 7-12 of the periodic table, and is applied via one of electroplating, atomic layer deposition, sputtering, or physical vapor deposition.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a solid oxide fuel cell;

FIG. 2 is a schematic illustration of an embodiment of a fuel cell having a multilayer structure;

FIG. 3 is a schematic illustration of an embodiment of a fuel cell layer;

FIG. 4 is another schematic illustration of an embodiment of a fuel cell layer;

FIG. 5 is a partially exploded view of an embodiment of a fuel cell layer; and

FIG. 6 is a schematic illustration of a method of forming a multi-layer fuel cell.

### DETAILED DESCRIPTION

A detailed description of one or more embodiments of the disclosed apparatus and method are presented herein by way of exemplification and not limitation with reference to the Figures.

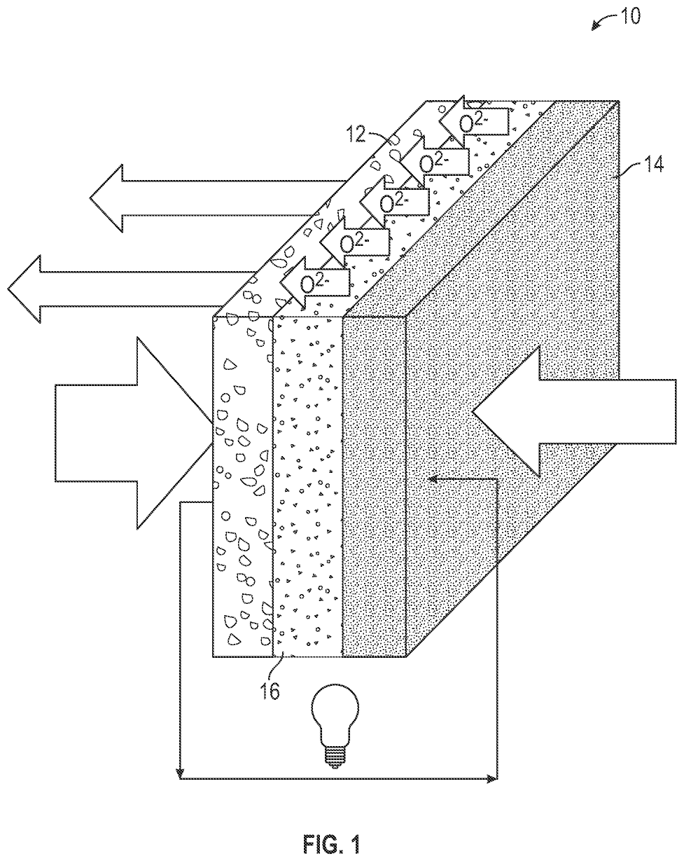

Referring to FIG. 1, shown is a schematic illustration of an embodiment of a fuel cell (10). In some embodiments, the fuel cell 10 is a solid oxide fuel cell, a proton conducting fuel cell, an electrolyzer, or other fuel cell apparatus. The fuel cell 10 includes an anode 12 and a cathode 14 with an electrolyte 16 disposed between the anode 12 and the cathode 14. In the case of the solid oxide fuel cell 10, the electrolyte 16 is a solid oxide material such as, for example, a ceramic material. A flow of fuel is introduced to the fuel cell 10 along with a flow of air. Chemical reactions of the fuel fed to the anode 12 and air fed to the cathode 14, passing charged species, such as protons, through the electrolyte 16 produces electricity. In some embodiments, an operating temperature of the fuel cell 10 is in the range of 400-900 degrees Celsius, while in other embodiments the operating temperature is in the range of 400-750 degrees Celsius. The flow of fuel may comprise, for example, natural gas, coal gas, biogas, hydrogen, or other fuels such as jet fuel.

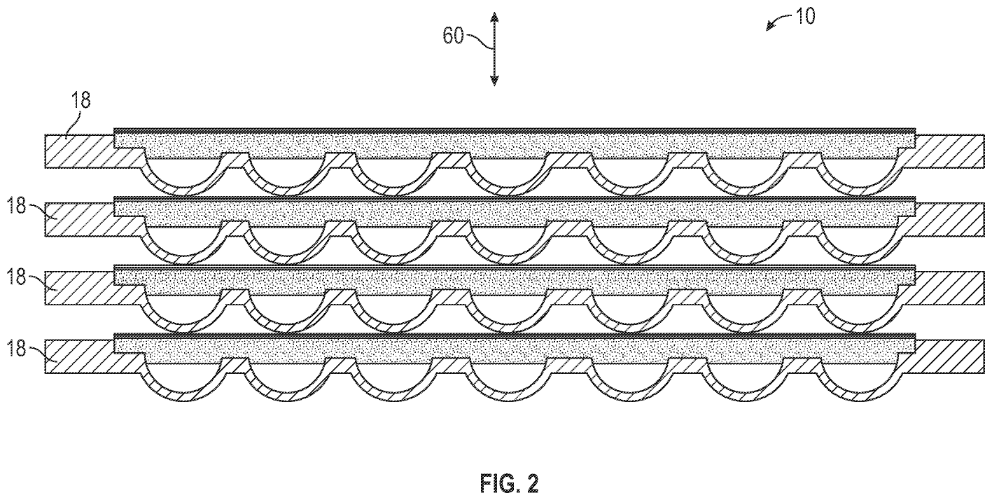

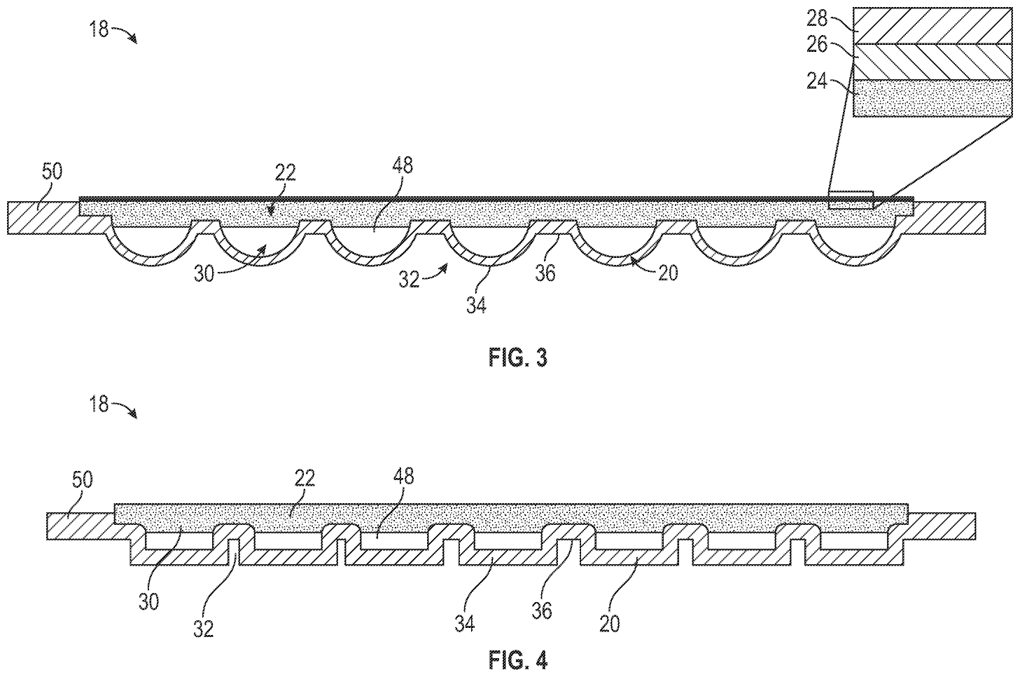

Referring now to FIG. 2, the fuel cell 10 includes a plurality of fuel cell layers 18 stacked along a stacking axis 60. In some embodiments, each fuel cell layer 18 has a rectangular shape. It is to be appreciated, however, that the fuel cell layers 18 may have other polygonal shapes or may be, for example, circular, elliptical or oval in shape. As shown in FIG. 3, each fuel cell layer 18 includes a separator plate 20 and a support 22 located over the separator plate 20 with the support 22 secured to the separator plate 20. Joining the support 22 to the separator plate 20 increases their individual strength and rigidity, and allows for using thinner, lighter materials in forming the support 22 and the separator plate 20 than would be otherwise feasible. An anode 24, electrolyte 26 and a cathode 28 are stacked atop the support 22 in that order. In some embodiments, the electrolyte 26 is formed from a solid oxide material, such as a ceramic material. The fuel cell layers 18 are stacked such that the cathode 28 contacts the separator plate 20 of the neighboring fuel cell layer 18.

The separator plate 20 is compliant and lightweight and is shaped to define a plurality of anode flow channels 30 and a plurality of cathode flow channels 32 and separate the anode flow channels 30 from the cathode flow channels 32. The plurality of anode flow channels 30 are defined at a first side of the separator plate 20 and the plurality of cathode flow channels 32 are defined at a second side of the separator plate 20 opposite the first side. As illustrated the anode flow channels 30 and the cathode flow channels 32 at least partially overlap along the stacking axis 60. This improves a density of the fuel cell 10 along the stacking axis 60.

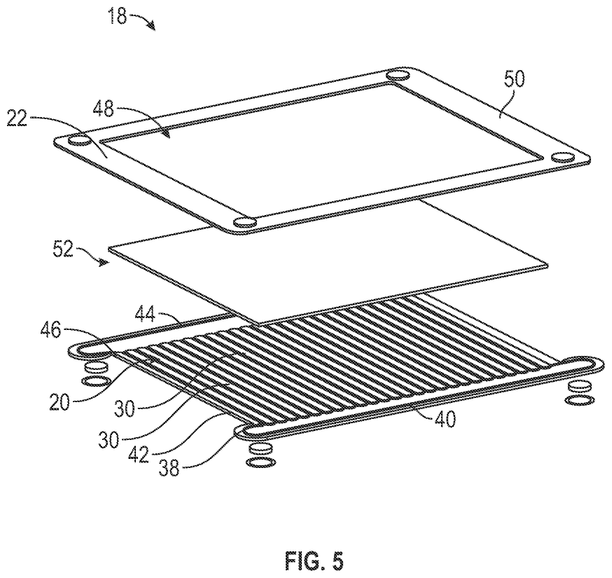

Compliance of the separator plate 20 ensures good contact with the cathode 28 for high performance, and the separator plate 20 is configured for light weight to enable high power density of the fuel cell 10. The fuel flows through the anode flow channels 30 and the air flows through the cathode flow channels 32. In some embodiments, such as in FIG. 3, the separator plate 20 includes a plurality of curved portions 34 separated by flat support portions 36, with the support portions 36 interfacing with the support 22 and curved portions 34 contacting the cathode 28 of the neighboring fuel cell layer 18. The waveform shape of the separator plate 20 with the plurality of curved portions 34 allows for greater levels of fuel flow coverage to the anode 24 and a greater level of airflow coverage to the cathode 28. In other embodiments, the curved portions 34 may have other shapes, such as rectilinear as shown in FIG. 4. The shapes illustrated in FIGS. 3 and 4 are merely exemplary, with the shapes of anode flow channels 30 and cathode flow channels 32 selected to provide the desired compliance in the stacking axis 60 direction, while allowing for selected anode and cathode flows which may be at significantly different flow rates. The separator plate 20 may be formed from corrugated sheet stock with features on the order of millimeters to centimeters. Alternatively, the separator plate 20 may be formed from sheet material by, for example, stamping, extrusion, folding, bending, roll forming, hydroforming, or the like. Other methods may include injection molding, additive manufacturing including laser powder bed fusion, electron beam melting, directed energy deposition, or laminated object manufacture. In still other embodiments, the separator plate may be formed at least partially by a process such as ultraviolet lithography and etching which may be used to form features with a resolution below 10 microns, or by micro-EDM (electrical discharge machining) or laser micromachining, both of which that may be utilized to produce features with a resolution in the range of 50 to 100 microns. In some embodiments, the separator plate 20 is formed from a stainless steel or titanium material.

Referring again to FIG. 3 and also to the partially exploded view of FIG. 5, fuel is distributed to the anode fuel channels 30 via a primary manifold 38 and a secondary manifold 40. The primary manifold 38 extends between the fuel cell layers 18 to distribute fuel to each fuel cell layer 18 of the plurality of fuel cell layers 18. Each fuel cell layer 18 includes a secondary manifold 40 located at, for example, a first end 42 of the anode flow channels 30. The secondary manifold 40 is connected to the primary manifold 38 and the plurality of anode flow channels 30 to distribute fuel from the primary manifold 38 to each of the anode flow channels 30 of the fuel cell layer 18. The anode flow channels 30 extend from the secondary manifold 40 at the first end 42 of the anode flow channels 30 to a collection manifold 44 at a second end 46 of the anode flow channels 30. Fuel flows from the primary manifold 38 through the secondary manifold 40, and through the anode flow channels 30 with anode byproducts such as water vapor and carbon dioxide exiting the anode flow channels 30 and flowing into the collection manifold 44.

The support layer 22 is formed from a metal material in some embodiments, and includes a porous section 48 and a non-porous or solid section 50, with the solid section 50 surrounding the porous section 48 and defining an outer perimeter of the support layer 22. The porous section 48 may be formed by, for example, laser drilling of a metal sheet. or sintering of metal powder, or additive manufacturing. The porous section 48 is located over the anode flow channels 30 to allow the fuel flow to reach the anode 24 through the porous section 48. In some embodiments, a metal catalyst foam layer 52 is located between the separator plate 20 and the support layer 22.

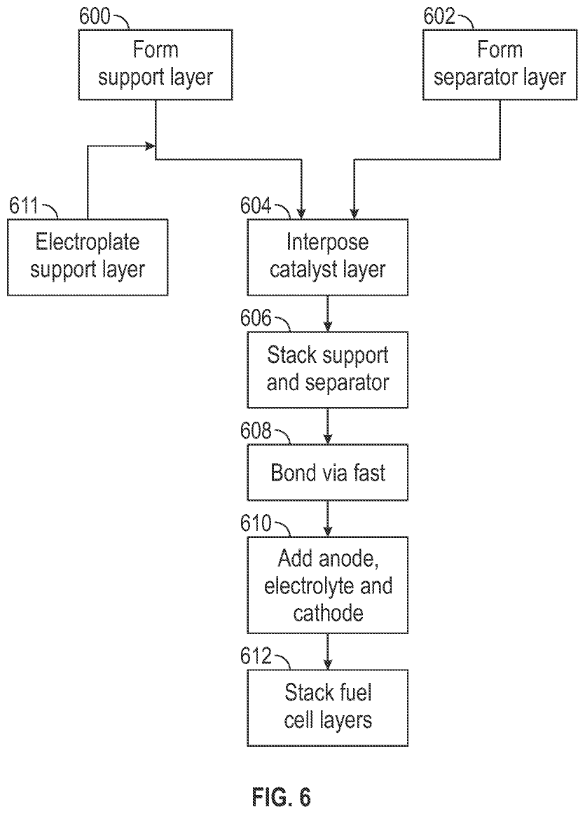

Referring now to FIG. 6, illustrated is a method of forming a unitary separator plate 20 and support layer 22. At step 600, the support layer 22 is formed by, for example, laser drilling of a metal sheet to define a desired porous section 48 and solid section 50. In some embodiments, the support layer 22 is formed from a ferrous metal such as stainless steel. At step 602, the separator plate 20 is formed as a corrugated sheet with the desired curved portions 34 and support portions 36. The separator plate 20 may include a border portion along at least one side of the separator plate 20 which is not corrugated and is absent of the curved portions. In some embodiments, the separator plate 20 is also formed from a ferrous metal such as stainless steel. The separator plate 20 is relatively compliant to ensure good contact with the cathode 28 of the adjacent layer, and is relatively light weight to enable a high power density of the fuel cell 10. In some embodiments, at step 604, the metal catalyst foam layer 52 is placed between the separator plate 20 and the support layer 22, and at step 606 the support layer 22 is stacked onto the separator plate 20, with the solid section 50 of the support layer 22 aligned with the border portion of the separator plate 20. At step 608, the support layer 22 is bonded to the separator plate 20 via a field assisted sintering technology (FAST) process, also known as spark plasma sintering or direct current sintering. The FAST process is performed at an elevated temperature, for example, a temperature less than 1000 degrees Celsius, or in some embodiments in the range of 800-1000 degrees Celsius. The FAST process is also performed at an elevated pressure in the range of 5-100 MPa, or in some embodiments in the range of 10-40 MPa, and with a dwell time in the range of 1-30 minutes. This secures the support layer 22 to the separator plate 20.

Referring to FIG. 3 with continued reference to FIG. 6, the anode 24, electrolyte 26 and the cathode 28 are stacked atop the support layer 22 at step 610. In some embodiments, the anode 24, electrolyte 26 and the cathode 28 are formed as tape casted ceramic layers and secured to the support layer 22 via, for example, sintering or FAST. In one embodiment, the anode 24, electrolyte 26 and the cathode 28 may be secured in place via the same FAST process used to secure the support layer 22 to the separator plate 20. In some embodiments, at step 611 the support layer 22 is electroplated with a thin conductive layer, having a thickness in the range of 5 micrometers to 1 millimeter, prior to FAST. The thin conductive layer primarily includes elements from groups 7-12 of the periodic table, which in some embodiments is a nickel or nickel alloy material. The electroplating is utilized to prevent Cr scale formation between the anode 24 and the support layer 22. In other embodiments, the thin conductive layer may be applied via atomic layer deposition (ALD), sputtering, or physical vapor deposition (PVD).

The separator plate 20, support layer 22, anode 24, electrolyte 26 and cathode 28 assembled as above define a repeating layer unit. These repeating units, or fuel cell layers 18, are then stacked in step 612 along the stacking axis 60 as illustrated in FIG. 2 to define the fuel cell 10.

The fuel cell 10 configurations disclosed herein enable a high performance electrical power system for, for example, an aircraft, especially for long duration operation. The configurations further reduce startup times and provide power densities in the range of 1-3 kilowatts/kilogram with a cell performance of ≥0.8 W/cm². Further, the improved power density may be achieved utilizing a lightweight separator plate 20, with a separator plate 20 formed from, for example, stainless steel having a thickness of 2 mil to 10 mil. Further, other materials such as titanium alloys, or other materials at lower operating temperatures may be used to form a lightweight separator plate 20.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of forming a fuel cell layer, comprising:
forming a separator plate including a plurality of corrugations defining a plurality of anode flow channels at a first side of the separator plate and a plurality of cathode flow channels at a second side of the separator plate opposite the first side;
forming a support layer, the support layer including a porous portion and a solid portion at least partially surrounding the porous portion;
stacking the support layer and the separator plate; and
securing the support layer to the separator plate via a field-assisted sintering or spark plasma sintering (FAST) process.

2. The method of claim 1, further comprising interposing a catalyst layer between the support layer and the separator plate.

3. The method of claim 1, further comprising performing the securing at a temperature in the range of less than or equal to 1000 degrees Celsius.

4. The method of claim 1, further comprising performing the securing at a pressure in the range of 5 to 100 Megapascals.

5. The method of claim 1, wherein the porous portion of the support layer is formed by laser drilling.

6. The method of claim 1, further comprising applying anode, electrolyte and cathode layers to the support layer.

7. The method of claim 6, wherein at least one of the anode, electrolyte and cathode are formed as tape casted ceramic layers.

8. The method of claim 6, further comprising securing one or more of the anode, electrolyte and cathode via one of a FAST or spark plasma sintering process.

9. The method of claim 1, further comprising applying a thin conductive layer having a thickness in the range of 5 micrometers to 1 millimeter to the support layer, the thin conductive layer formed primarily of elements from groups 7-12 of the periodic table.

10. The method of claim 9, wherein the thin conductive layer is one of a nickel or nickel alloy.

11. The method of claim 9, further comprising applying the thin conductive layer via one of electroplating, atomic layer deposition, sputtering, or physical vapor deposition.

12. The method of claim 9, further comprising applying the thin conductive layer prior to securing the support layer to the separator plate.

13. The method of claim 1, wherein at least one of the separator plate or the support layer are formed from a stainless steel material.

14. A method of forming a stacked solid oxide fuel cell, comprising:
forming a plurality of fuel cell layers, each fuel cell layer formed via:
forming a separator plate including a plurality of corrugations defining a plurality of anode flow channels at a first side of the separator plate and a plurality of cathode flow channels at a second side of the separator plate opposite the first side;
forming a support layer, the support layer including a porous portion and a solid portion at least partially surrounding the porous portion;
stacking the support layer and the separator plate; and
securing the support layer to the separator plate via a field-assisted sintering or spark plasma sintering (FAST) process; and
stacking the plurality of fuel cell layers along a stacking axis.

15. The method of claim 14, further comprising performing the securing at a temperature less than or equal to 1000 degrees Celsius.

16. The method of claim 14, further comprising performing the securing at a pressure in the range of 5 to 100 Megapascals.

17. The method of claim 14, further comprising applying anode, electrolyte and cathode layers to the support layer.

18. The method of claim 1, further comprising applying a thin conductive layer having a thickness in the range of 5 micrometers to 1 millimeter to the support layer, the thin conductive layer formed primarily of elements from groups 7-12 of the periodic table, the thin conductive layer applied via one of electroplating, atomic layer deposition, sputtering, or physical vapor deposition.

19. A fuel cell layer of a multi-layer fuel cell, comprising:
a cathode;
an anode;
an electrolyte disposed between the anode and the cathode;
a support layer disposed at the anode opposite the electrolyte;
a separator plate disposed at the support layer opposite the anode, the support layer configured to contact the cathode of an adjacent fuel cell layer, the separator plate defining a plurality of anode flow channels configured to deliver a fuel therethrough and a plurality of cathode flow channels configured to deliver an air flow therethrough;
wherein the support layer is secured to the separator plate via a field-assisted sintering or spark plasma sintering (FAST) process.

20. The fuel cell layer of claim 19, further comprising a thin conductive layer applied to the support layer having a thickness in the range of 5 micrometers to 1 millimeter, the thin conductive layer formed primarily of elements from groups 7-12 of the periodic table, the thin conductive layer applied via one of electroplating, atomic layer deposition, sputtering, or physical vapor deposition.
